(19) United States
(12) Patent Application Publication
(10) Pub. No.: US 2024/0346224 A1
(43) Pub. Date: Oct. 17, 2024

(54) SIGNAL TRANSFER WITH A BRIDGE AND HYBRID BUMPS

(71) Applicants: Mahesh K. Kumashikar, Bangalore (IN); Atul Maheshwari, Portland, OR (US); MD Altaf Hossain, Portland, OR (US); Ankireddy Nalamalpu, Portland, OR (US); Krishna Bharath Kolluru, Hillsboro, OR (US)

(72) Inventors: Mahesh K. Kumashikar, Bangalore (IN); Atul Maheshwari, Portland, OR (US); MD Altaf Hossain, Portland, OR (US); Ankireddy Nalamalpu, Portland, OR (US); Krishna Bharath Kolluru, Hillsboro, OR (US)

(21) Appl. No.: 18/757,046

(22) Filed: Jun. 27, 2024

(51) Int. Cl. G06F 30/392; G06F 30/33; G06F 119/10

(52) U.S. Cl. CPC G06F 30/392; G06F 30/33; G06F 2119/10

(57) ABSTRACT

Systems or methods of the present disclosure may provide a multi-chip package with two or more integrated circuit devices that each include hybrid bumps. The hybrid bumps may include bumps of different sizes to facilitate different types of communication. For example, the hybrid bumps may include a first bump with fine pitch for die-to-die communication and/or a second bump with a large pitch for off-package communication. The multi-chip package may include a bridge to facilitate signal transfer between the integrated circuit device with the hybrid bumps and other components within the multi-chip package. Additionally or alternatively, the multi-chip package may include an interconnect to facilitate signal transfer between two integrated circuit devices. The interconnect may include fine pitch bumps, which may be translated by an interposer to a pitch size of the bridge. As such, the interconnect may facilitate die-to-die communication and/or off-package communication.

### BACKGROUND

The present disclosure relates generally to integrated circuits, such as processors and/or field-programmable gate arrays (FPGAs). More particularly, the present disclosure relates to reducing design complexity of programmable logic devices, such as high-capacity field programmable gate arrays (FPGAs).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Modern electronics, such as computers, portable devices, network routers, data centers, Internet-connected appliances, and more, tend to include at least one integrated circuit device. Integrated circuit devices may take on a variety of forms, including processors (e.g., central processing units (CPUs)), memory devices, and programmable devices (e.g., FPGA), to name only a few examples. In certain instances, a multi-chip package may include two or more integrated circuit devices may be coupled together via a silicon bridge, such as an embedded multi-die interconnect bridge (EMIB)). However, the use of a silicon bridge may increase design complexity, increase manufacturing costs, and/or decrease scalability of a multi-chip package.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is cross-sectional view of a multi-chip package with the integrated circuit device of FIG. 1, in accordance with an embodiment of the present disclosure;

FIG. 4 is a top down view of a multi-chip package with eight integrated circuit devices of FIG. 1 coupled together via interposers and bridges, in accordance with an embodiment of the present disclosure;

FIG. 5 is a top down view of a multi-chip package with eight-integrated circuit devices of FIG. 1 coupled together via interposers, in accordance with an embodiment of the present disclosure; and

FIG. 6 is a is a block diagram of a data processing system including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present systems and techniques relate to embodiments for coupling two or more integrated circuit devices to form a multi-die package. For example, the integrated circuit devices may include bumps (e.g., microbumps) with uniform pitch sizes for signal transfer. The bumps may be limited to one type of signal transfer (e.g., communication). For example, fine pitched bumps may facilitate die-to-die communication while large pitched bumps may facilitate off-package communication. Additionally or alternatively, the bumps may couple to a silicon bridge for die-to-die communication and/or an interposer for off-package communication. As such, the integrated circuit die may include fine pitched bumps, large pitched bumps, an interposer, and/or a silicon bridge for different types of signal transfer to different components within the package and/or off the package, thereby increasing design complexity and/or manufacturing complexity.

Embodiments of the present disclosure include a multi-chip package with two or more integrated circuit devices that include and/or use hybrid bumps for communication. For example, an integrated circuit device (e.g., die) within the multi-chip package may include hybrid bumps on a surface of the die. The hybrid bumps may include bumps of different sizes to facilitate different types of communication. For example, the hybrid bumps may include a first bump with a fine pitch size for die-to-die communication and/or a second bump with a large pitch size for off-package communication. To facilitate the communication, the multi-chip package may include a bridge, such as a Fan-Out Embedded Bridge technology (FO-EB-T) that may facilitate signal transfer between the integrated circuit with the hybrid bumps and other components, such as other integrated circuits, an interconnect, an interposer, a substrate, and so on. Additionally or alternatively, the multi-chip package may include an interconnect, such as a hybrid bonding interconnect (HBI), to facilitate signal transfer to and/or from an integrated circuit device. The HBI may include fine pitch bumps that couple to a surface of the integrated circuit device, while the bridge may include large pitch bumps. The fine pitch bumps of the HBI may not communicatively couple to the large pitch bumps of the bridge. In certain instances, the integrated circuit device may couple to an interposer, which may be an active interposer or a passive interposer, that translates (e.g., converts) the fine pitch bumps of the interconnect to the large pitch bumps of the bridge. For example, the interposer may couple to the HBI via a first surface and couple to the large pitch bumps of the bridge via a second surface. As such, the interposer may communicatively couple the integrated circuit device and/or the HBI to other components within the multi-die package. Accordingly, the hybrid bumps may facilitate signal transfer between components within the multi-chip package.

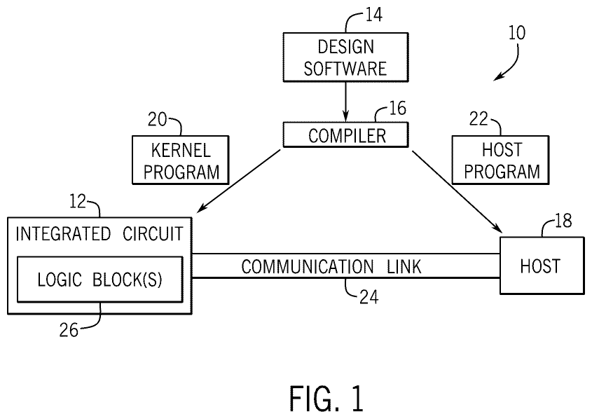

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL™, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

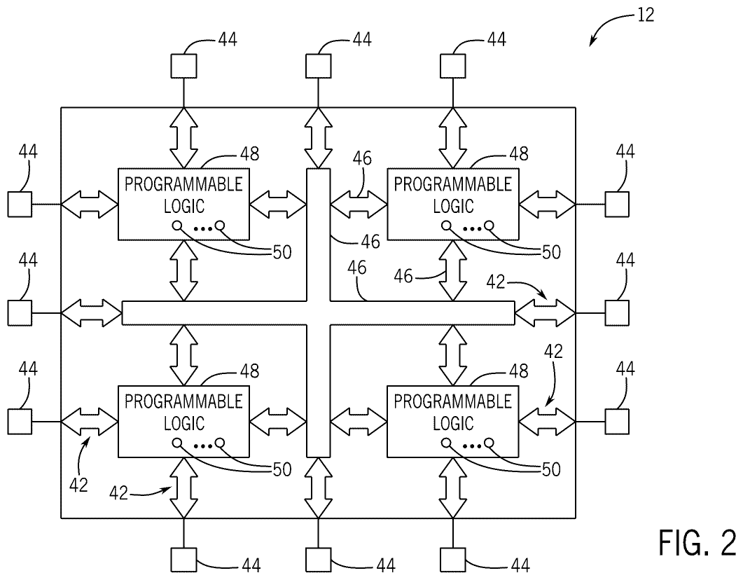

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on integrated circuit device 12. Additionally, interconnection resources 46 may include fixed interconnects (conductive lines) and programmable interconnects (e.g., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

The integrated circuit device 12 may include any programmable logic device such as a field programmable gate array (FPGA) 70. For the purposes of this example, the FPGA 70 is referred to as a FPGA, though it should be understood that the device may be any suitable type of programmable logic device (e.g., an application-specific integrated circuit and/or application-specific standard product).

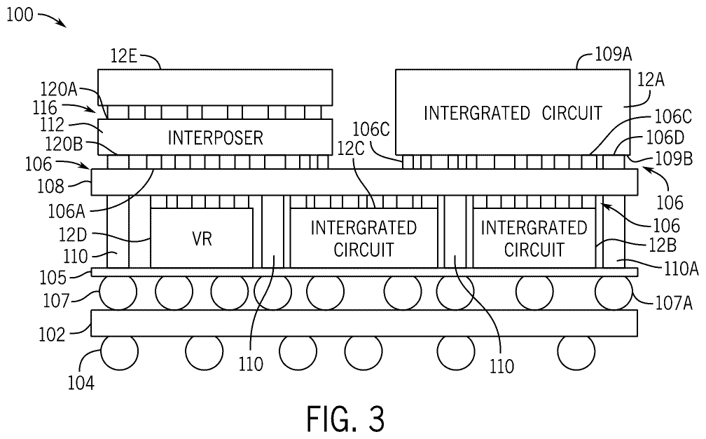

FIG. 3 is a cross-sectional view of a multi-chip package 100 with multiple integrated circuit devices 12. The multi-chip package 100 may be system-in-package (SiP), a flip-chip package, a multi-chip module, a 2.5 dimensional (2.5D) package, a three-dimensional (3D) package, or the like. The multi-chip package 100 may be mounted on top of a package substrate (e.g., printed circuit board (PCB)). For example, the multi-chip package 100 may include a substrate 102 that may be mounted on top of the package substrate via solder balls 104. The multi-chip package 100 may also include one or more integrated circuit devices 12 mounted on top of the substrate 102. The substrate 102 may transfer signals from the multi-chip package 100 to other circuitry mounted on the package substrate, such as other devices, external connections, and the like. The integrated circuit devices 12 may be communicatively coupled to the substrate 102 via an redistribution layer (RDL 105 and bumps 107. The bumps 107 that interface directly with the substrate 102 may be referred to as controlled collapse chip connection (C4) bumps or “flip-chip” bumps and may have pitch size (e.g., diameter) of 100 microns.

As illustrated, the multi-chip package 100 may include multiple integrated circuit devices 12. In an example shown in FIG. 3, there are five integrated circuit devices 12A, 12B, 12C, 12D, and 12E, but other examples in which the multi-chip package 100 may include more integrated circuit devices 12 or fewer integrated circuit devices 12. For example, the first integrated circuit device 12A may be a silicon die, the third integrated circuit device 12C may be a bridge die, the second integrated circuit device 12B and/or the fourth integrated circuit device 12D may be a voltage regulator die, and the fifth integrated circuit device 12E may be a silicon die. In certain instances, the third integrated circuit device 12C may include voltage regulation circuitry and/or a voltage regulator embedded within the integrated circuit device 12C. In other instances, the third integrated circuit device 12C may include an embedded memory and/or additional embedded functionalities. By embedding voltage regulation circuitry and/or memory circuitry within an integrated circuit device 12, a size of the multi-chip package 100 may be decreased and/or a density of the multi-chip package 100 may be increased. This modification may increase the package substrate 102 area that may be suitable for other circuit components without increasing the package substrate 102 area. It may be understood that the example of FIG. 3 is merely illustrative, and the multi-chip package 100 may include any suitable number of integrated circuit devices 12 with any suitable circuitry embedded within and/or implemented on the integrated circuit device 12.

The integrated circuit devices 12 may be mounted laterally with respect to each other in a 2.5-dimensional (2.5D) stack and/or vertically with respect to each other in a 3-dimensional (3D) stack. For example, a first integrated circuit device 12A may be stacked on top of a second integrated circuit device 12B and/or a third integrated circuit device 12C and mounted laterally with respect to the fifth integrated circuit device 12E. Additionally or alternatively, the second integrated circuit device 12B, the third integrated circuit device 12C, and/or the fourth integrated circuit device 12D may be mounted laterally with respect to one another on the substrate 102.

The integrated circuit devices 12 communicatively couple to other components within the multi-chip package 100 via a first surface 109A or a second surface 109B. The first surface 109A and/or the second surface 109B of the integrated circuit device 12 may include interconnect layers (e.g., a dielectric stack) with alternating layers of metal routing layers (e.g., dielectric layers in which metal routing paths may be formed) and via layers (e.g., dielectric layers through which metal vias can be formed for electrically connecting paths from one metal routing layer to paths in another metal routing layer). Additionally or alternatively, the integrated circuit devices 12 may include input/output circuitry (e.g., 3D input/output circuitry, 2.5D input/output circuitry) on the first surface 109A and/or the second surface 109B to facilitate signal transfer (e.g., communication) between the integrated circuit devices 12 and/or other circuitry off the multi-chip package 100. By way of example, the first integrated circuit device 12A may include input/output circuitry on the first surface 109A to facilitate communication with another component that may be mounted on the first integrated circuit device 12A. For example, the first surface 109A of the first integrated circuit device 12A may couple to an additional integrated circuit device 12 and the input/output circuitry on the first surface 109A may facilitate communication between the first integrated circuit device 12A and the additional integrated circuit device 12. In another example, the second surface 109B of the first integrated circuit device 12A may couple to an interposer and the input/output circuitry on the second surface 109B to facilitate communication between the first integrated circuit device 12A and the interposer.

The integrated circuit devices 12 may include hybrid bumps 106 to facilitate communication within the multi-die package 100 and/or off-package communication. The hybrid bumps 106 may refer to solder bumps coupled to and/or formed on a surface (e.g., the first surface 109A, the second surface 109B) of the integrated circuit device 12. The hybrid bumps 106 may be of any suitable pitch size and/or include different pitch sizes. For example, the hybrid bumps 106 may include a first bump 106A with a first pitch size and/or a second bump 106B with a second pitch size. The first pitch size and the second pitch size may be different. For example, the first bump 106A may be smaller than the second bump 106B. Additionally or alternatively, the hybrid bumps 106 may include three or more bumps that each include a different pitch size. In other instances, the hybrid bumps 106 may include two or more bumps, such as the first bump 106A and the third bump 106C, with the same pitch size. The hybrid bumps 106 may include fine pitch bumps, large pitch bumps, micro-bumps with a pitch size (e.g., diameter) of 10 microns or less, bumps with a pitch size of 25 microns or less, bumps with a pitch size of 25 microns or more, and so on. The hybrid bumps 106 may include multiple bumps of different pitch sizes and/or two or more bumps with the same pitch size. The hybrid bumps 106 may be in any suitable pattern to couple together two integrated circuit devices 12, couple to the integrated circuit device 12 to the bridge 108, or both. As such, the hybrid bumps 106 may include bumps of any suitable size to facilitate both on-package signal transfer and off-package signal transfer, thereby reducing a number of bump patterns used to manufacture the multi-chip package 100.

The hybrid bumps 106 of the first integrated circuit device 12A may couple to the bridge (e.g., fanout embedded bridge technology (FO-EB)) 108 to facilitate signal transfer to and from the first integrated circuit device 12A. The bridge 108 may include input/outsput circuitry to receive the hybrid bumps 106 of the integrated circuit devices 12. For example, the bridge 108 may include interconnects to couple to hybrid bumps 106 on both surfaces of the bridge 108. As illustrated, the bridge 108 may couple to the hybrid bumps 106 of the first integrated circuit device 12A and the hybrid bumps 106 of a second integrated circuit device 12B to communicatively couple the two integrated circuit devices 12 in a 3D stack. Additionally or alternatively, the bridge 108 may communicatively couple the third integrated circuit device 12C and the fourth integrated circuit device 12D with the first integrated circuit device 12A and the second integrated circuit device 12B via the hybrid bump 106. In certain instances, the bridge 108 may route power between the integrated circuit devices 12, such as from a power source and/or an integrated circuit device 12 with an embedded voltage regulator, such as the fourth integrated circuit device 12D. As such, the bridge 108 may facilitate signal transfer and/or voltage transfer between two or more integrated circuit devices 12 in a 3D stack.

The bridge 108 may also facilitate signal transfer between two or more integrated circuit devices 12 in a 2.5D stack. For example, the second integrated circuit device 12B, the third integrated circuit device 12C, and the fourth integrated circuit device 12D may be mounted laterally with respect to each other. The second integrated circuit device 12B may transmit a signal to the third integrated circuit device 12C and/or the fourth integrated circuit device 12D via the bridge 108 and/or the hybrid bumps 106. The bridge 108 may also communicatively couple the first integrated circuit device 12A to the fifth integrated circuit device 12E. As such, the bridge 108 may facilitate signal transfer between the integrated circuit devices 12 of the multi-chip package 100.

The integrated circuit devices 12 may communicate with circuitry on the package substrate via the bumps 107 and the substrate 102. For integrated circuit devices 12 mounted onto the substrate 102, such as the second integrated circuit device 12B, the third integrated circuit device 12C, and/or the fourth integrated circuit device 12D, off-package communication may be facilitated through the bumps 107 and the substrate 102. For integrated circuit devices 12 coupled to the substrate 102 via the bridge 108, such as the first integrated circuit device 12A, the multi-chip package 100 may include a copper pillar 110 to couple the integrated circuit device 12 to the bumps 107 and the substrate 102. For example, the copper pillar 119 may directly couple to the bridge 108 and the bump 107 via the RDL 105. For example, a hybrid bump 106 of the first integrated circuit device 12A may couple to the bridge 108, and a copper pillar 110 may couple the bridge 108 to a bump 107. The copper pillar 110 may be an interconnect that couples the bridge 108 to the substrate 102 via the bump 107. As such, the copper pillar 110 may provide an electrical connection between an integrated circuit device 12 and the package substrate 102. In another example, a first copper pillar 110A may facilitate signal transfer between a fourth hybrid bump 106D of the first integrated circuit device 12A and the package substrate 102 via a first bump 107D and the bridge 108. As illustrated, the first copper pillar 110A may extend from the bridge 108 to the first bump 107A, thereby providing an electrical connection between the two components. As such, the copper pillar 110 may facilitate off-package communication to and from the integrated circuit devices 12. Additionally or alternatively, the copper pillars 110 may provide a mechanical support to the integrated circuit devices 12 within the multi-die package 100, such as the first integrated circuit device 12A and/or the fifth integrated circuit device 12D.

In certain instances, the multi-chip package 100 may include an interposer 112 communicatively coupled to an integrated circuit device 12. For example, the integrated circuit device 12 may include and/or couple to a hybrid bonding interconnect (HBI) 116. The HBI 116 may include microbumps formed on a surface (e.g., the first surface 109A, the second surface 109B) of the integrated circuit device 12. The HBI 116 may include microbumps with a uniform pitch. Additionally or alternatively, the HBI 116 may include a fine pitch size, such as a pitch size of 9 microns or less. By way of example, the fifth integrated circuit device 12E may include the HBI 116 formed on and/or coupled to the HBI 116 on the second surface 109B. The fifth integrated circuit device 12E may couple to the bridge 108 via the interposer 112. The interposer 112 may include microbumps on a first surface to couple to the fifth integrated circuit device 12E and hybrid bumps 106 on a second surface to couple with the bridge 108. The interposer 112 may be a passive interposer or an active interposer.

The bridge 108 may include a pitch size greater than the pitch size of the HBI 116. For example, the bridge 108 may include a pitch size of 20 microns or more. As such, the interposer 112 may facilitate a translation (e.g., conversion) between the pitch size of the HBI 116 coupled to the fifth integrated circuit device 12E and the pitch size of the bridge 108. For example, the interposer 112 may translate the pitch size of the HBI 116 to the pitch to the bridge 108. To this end, the interposer 112 may include a first surface 120A with input/output pins that interface with the HBI 116 and a second surface 120B that includes input/output circuitry to interface the hybrid bumps 106 to communicatively couple to the bridge 108. The interposer 112 may receive signals from the fifth integrated circuit device 12E via the input/output pins and the HBI 116 and transfer the signals to the bridge 108 via the input/output pins and the hybrid bumps 106 or vice versa. As such, the interposer 112 may pass signals to and from integrated circuit devices 12 coupled to the HBI 116.

The interposer 112 may couple the fifth integrated circuit device 12E to components within the multi-chip package 100. For example, the fifth integrated circuit device 12E may couple to the fourth integrated circuit device 12D in a 3D stack via the interposer 112 and the bridge 108. The fifth integrated circuit device 12E may also be communicatively coupled to the first integrated circuit device 12A, the second integrated circuit device 12B, and/or the third integrated circuit device 12C via the interposer 112 and the bridge 108. Additionally or alternatively, the fifth integrated circuit device 12E may couple to the package substrate 102, via the interposer 112 and a copper pillar 110, thereby communicating with circuitry mounted on the package substrate 102.

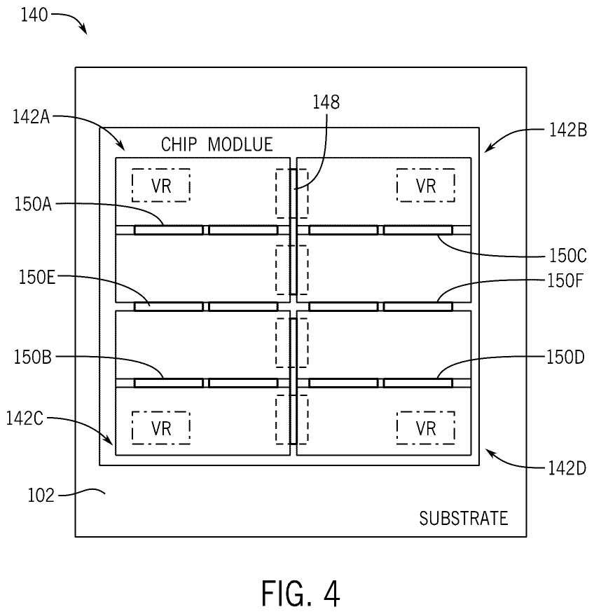

FIG. 4 is a top down view of a multi-chip package 140 with eight integrated circuit devices 12 coupled together via interposers 148 (e.g., the interposer 112 described with respect to FIG. 3) and bridges 150 (e.g., the bridge 108 described with respect to FIG. 3). As illustrated, the multi-chip package 140 may include a package substrate 102 with a first multi-chip package 142A, a second multi-chip package 142B, a third multi-chip package 142C, and a fourth multi-chip package 142D mounted on top of the package substrate 102. For example, each multi-die package 140 may include multiple the integrated circuit devices 12. The integrated circuit devices 12 may include fabric dies that operate as programmable logic devices, such as field programmable gate arrays (FPGA). The integrated circuit device 12 may be programmed via a bitstream (e.g., configuration bitstream) with a functionality and/or an operation. In other examples, the integrated circuit device 12 may include embedded circuitry, such as circuitry for voltage regulation, memory, and so on. By embedding certain circuitry and/or functionality into the integrated circuit device 12, the package substrate 102 area may decrease and additional components, such as application specific components, may be added to the package substrate 102 by increasing a density of the multi-chip package 140. For example, additional integrated circuit devices 12 may be added to the multi-chip package 140 without increasing a size of the package substrate 102 and/or a size of the multi-chip package 140.

The multi-chip package 140 may include four multi-chip packages 142 (e.g., the multi-chip package 100 described with respect to FIG. 3). Each multi-chip package 142 may include two integrated circuit devices 12, such as the first integrated circuit device 12A and the fifth integrated circuit device 12E described with respect to FIG. 3, coupled together by the bridge 150. The bridge 150 may facilitate signal transfer between the components of the multi-die package 142. For example, the bridge 150 may facilitate signal transfer between the first integrated circuit device 12A of the first multi-die package 142A and the second integrated circuit device 12B of the first multi-die package 142A, the third integrated circuit device 12C of the first multi-die package 142A, the fourth integrated circuit device 12D of the first multi-die package 142A, the fifth integrated circuit device 12E of the first multi-die package 142A, and so on. Additionally or alternatively, each multi-die package 142 may include copper pillars (e.g., the copper pillar 110 described with respect to FIG. 3) that communicatively couples the bridge 150 to the package substrate (e.g., the package substrate 102 described with respect to FIG. 3) via bumps (e.g., the bumps 107 described with respect to FIG. 3). Each multi-chip package 142 may also include a voltage regulatory die, such as the fourth integrated circuit device 12D described with respect to FIG. 3. In certain instances, the multi-chip package 142 may include one or more silicon bridges (e.g., an embedded multi-die interconnect bridge (EMIB)) to couple together one or more integrated circuit devices 12. For example, the silicon bridge may provide electrical connections between the first integrated circuit device 12A with the third integrated circuit device 12C and/or between the second integrated circuit device 12B with the fourth integrated circuit device 12D.

The multi-chip packages 142 may be communicatively coupled via an interposer 148. For example, the interposer 148 may be less than one reticle size and communicatively couple together two integrated circuit devices 12, such as the first integrated circuit device 12A of a first multi-die package 142A and a first integrated circuit device 12A of a second multi-die package 142B. Additionally or alternatively, an additional interposer 148 may communicatively couple together the fifth integrated circuit device 12E of the first multi-die package 142A to the fifth integrated circuit device 12E of the second multi-die package 142B. The interposer 148 may couple together the integrated circuit devices 12 of the multi-die packages 142 in any suitable manner. For example, the interposer 148 may communicatively couple a first integrated circuit device 12A of the fourth multi-chip package 142D to a fifth integrated circuit device 12E of the third multi-chip package 142C. The interposer 148 may facilitate signal transfer between two communicatively coupled integrated circuit devices 12, thereby facilitating signal transfer between to multi-chip packages 142.

The interposer 148 may also transmit signals within the multi-chip package 142. For example, within the first multi-chip package 142, the interposer 148 receive a signal from the first integrated circuit device 12A and transmit the signal to another component within the multi-chip package 142 via the bridge 150, such as to integrated circuit devices 12 within the first multi-chip package 142 and coupled to the first integrated circuit device 12A in a 3D stack or a 2.5D stack. The bridge 150 may receive the signal from the first integrated circuit device 12A and route the signal to another component, such as other integrated circuit devices 12, within the multi-chip package 142. For example, the bridge 150 may route the signal to the substrate 102 via the copper pillar for off-package communication, such as to the other multi-chip packages 142 of the multi-chip package 140 coupled to the package substrate 102.

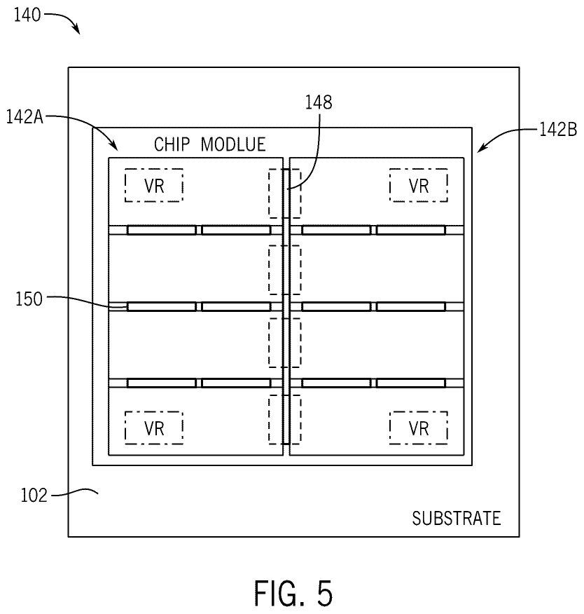

FIG. 5 is a top down view of the multi-chip package 140 with eight integrated circuit devices 12 coupled together via interposer 148 and bridges 150. The multi-chip package 100 of FIG. 5 is substantially similar to the multi-chip package 100 of FIG. 4, except the multi-chip package 100 of FIG. 5 includes an interposer 148 that is two times the reticle size and couples together four integrated circuit devices 12 instead of two integrated circuit devices 12. Since interposer 148 of FIG. 5 is larger than interposer 148 of FIG. 4, the number of interposers 148 within in the multi-chip package 140 of FIG. 5 may be less than the number of interposers 148 within the multi-chip package 140 of FIG. 4. Using fewer interposers 148 may improve the performance of the multi-chip package 140 since the interposers 148 may increase latency, increase manufacturing costs, increase design complexity, and the like.

As illustrated, the multi-die package 140 may include a first multi-die package 142A and a second multi-die package 142B mounted on a package substrate 102. The interposer 148 may communicatively couple the integrated circuit devices 12 of the first multi-die package 142A to respective integrated circuit devices 12 of the second multi-die package 142B, which may decrease latency, decrease manufacturing costs, and decrease design complexity.

In other embodiments, the interposer 148 may be four times the reticle size and couple together all eight integrated circuit devices 12 into one multi-die package 140. For example, the multi-die package 140 may include eight or more integrated circuit devices 12 coupled together via one interposer 148 and bridges 150. By decreasing a number of interposers 148, latency may decrease, manufacturing costs may decrease, and design complexity may decrease.

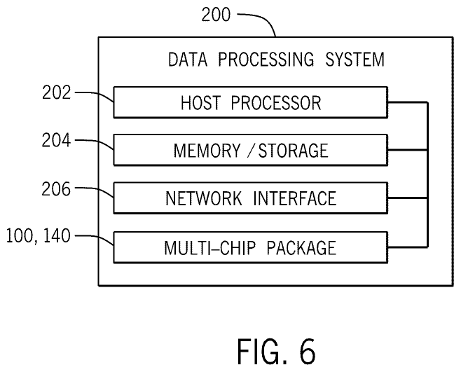

Bearing the foregoing in mind, the multi-chip package 100, 140 may be a component included in a data processing system, such as a data processing system 200, shown in FIG. 6. The data processing system 200 may include the multi-chip package 100, 140 (e.g., two or more integrated circuit devices 12), a host processor 202 (e.g., a processor), memory and/or storage circuitry 204, and a network interface 206. The data processing system 200 may include more or fewer components (e.g., electronic display, designer interface structures, ASICs). Moreover, any of the circuit components depicted in FIG. 6 may include integrated circuits, such as the integrated circuit device 12, and/or the multi-chip package 100, 140. The host processor 202 may include any of the foregoing processors that may manage a data processing request for the data processing system 200 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 204 may include random access memory (RAM), read-only memory (ROM), one or more hard drives, flash memory, or the like. The memory and/or storage circuitry 204 may hold data to be processed by the data processing system 200. In some cases, the memory and/or storage circuitry 204 may also store configuration programs (bit streams) for programming one or more integrated circuit devices 12 within the multi-chip package 100, 140. The network interface 206 may allow the data processing system 200 to communicate with other electronic devices. The data processing system 200 may include several different packages or may be contained within a single package on a single package substrate. For example, components of the data processing system 200 may be located on several different packages at one location (e.g., a data center) or multiple locations. For instance, components of the data processing system 200 may be located in separate geographic locations or areas, such as cities, states, or countries.

In one example, the data processing system 200 may be part of a data center that processes a variety of different requests. For instance, the data processing system 200 may receive a data processing request via the network interface 206 to perform encryption, decryption, machine learning, video processing, voice recognition, image recognition, data compression, database search ranking, bioinformatics, network security pattern identification, spatial navigation, digital signal processing, or some other specialized task.

The above discussion has been provided by way of example. Indeed, the embodiments of this disclosure may be susceptible to a variety of modifications and alternative forms. Indeed, the multi-chip package 100, 140 may include any suitable number of integrated circuit devices 12. Additionally or alternatively, the integrated circuit devices 12 may be embedded with any suitable circuitry.

Technical effects for designing the multi-chip package 100, 140 disclosed herein include integrated circuit devices 12 with hybrid bumps 106 that may communicate with other components of the multi-chip package 100, 140. The hybrid bumps 106 may include multiple bumps that have different pitch sizes to support different types of communication. For example, the hybrid bumps 106 may include fine pitch bumps for on-package communication and/or die-to-die communication and large pitch bumps for off-package communication. The hybrid bumps 106 may couple to a bridge 108, such as an FO-EB and/or an FO-EB-T, that transfers signals received from the hybrid bumps 106 to another component within the multi-die package 100, 140. For example, the bridge 108 may transfer the signal to another integrated circuit device 12 coupled to the integrated circuit device in a 3D stack or 2.5D stack. In another example, the bridge 108 may transfer the signal to the package substrate 102 via a copper pillar 110 for off-package communication. In this way, the hybrid bumps 106 may support both die-to-die communication and off-package communication. Additionally or alternatively, the multi-chip package 100, 140 may include an integrated circuit device 12 communicatively coupled to and/or integrated with a hybrid bonding interconnect (HBI) 114. The HBI 114 may include fine pitch bumps, which may be translated (e.g., converted) by an interposer 112 communicatively coupled to the HBI 114. The interposer 112 may include input/output circuitry that couples to the HBI 114 on a first surface and hybrid bumps 106 to couple the bridge 108 on a second surface. As such, the interposer 112 may translate the fine pitched bumps of the HBI 114 to the larger bumps of the bridge 108. By using hybrid bumps 106 within the multi-die package 100, 140, design complexity may decrease and manufacturing efficiency may increase.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

Example Embodiment 1. An integrated circuit system may include a first integrated circuit device communicatively coupled to a plurality of bumps, where the plurality of bumps comprises a first bump of the plurality of bumps having a first pitch size and a second bump of the plurality of bumps having a second pitch size, where the first pitch size is different from the second pitch size. The integrated circuit system may also include a bridge to communicatively the first integrated circuit device to a second integrated circuit device via the first bump and the first integrated circuit device to a package substrate via the second bump.

Example Embodiment 2. The integrated circuit system of example embodiment 1, where the first integrated circuit device and the second integrated circuit device are coupled in a stacked configuration.

Example Embodiment 3. The integrated circuit system of example embodiment 1, wherein the second integrated circuit device is embedded with a voltage regulator.

Example Embodiment 4. The integrated circuit system of example embodiment 2, including a third integrated circuit device positioned laterally with respect to the second integrated circuit device and configurable as a bridge die between the first integrated circuit device and the second integrated circuit device.

Example Embodiment 5. The integrated circuit system of example embodiment 1, including a copper pillar to communicatively couple the second bump via the bridge and couple the bridge to the package substrate.

Example Embodiment 6. The integrated circuit system of example embodiment 1, where the second pitch size is greater than the first pitch size.

Example Embodiment 7. The integrated circuit system of example embodiment 1, including an interconnect communicatively coupled to a second integrated circuit device and including a second plurality of bumps having a uniform pitch size and an interposer including a third plurality of bumps having different pitch sizes and configurable to communicatively couple to the second integrated circuit device to the bridge via the second plurality of bumps and the third plurality of bumps.

Example Embodiment 8. The integrated circuit system of example embodiment 7, where the interposer is passes a signal from the second integrated circuit device to the bridge.

Example Embodiment 9. The integrated circuit system of example embodiment 7, where a pitch size of the bridge is greater than the uniform pitch size of each bump of the second plurality of bumps.

Example Embodiment 10. The integrated circuit system of example embodiment 7, where the first integrated circuit device and the second integrated circuit device are coupled in a front-to-back connection.

Example Embodiment 11. An integrated circuit system may include a first integrated circuit device communicatively coupled to a first plurality of bumps, where the first plurality of bumps comprises a first bump of the first plurality of bumps having a first pitch size and a second bump of the first plurality of bumps having a second pitch size, a second integrated circuit device configurable to be embedded with voltage regulation circuitry, where the first integrated circuit device and the second integrated circuit device are in a stacked configuration, and a bridge to couple to the first integrated circuit device and the second integrated circuit device and facilitate signal transfer between the first integrated circuit device and the second integrated circuit device. The first pitch size of the first bump is different from the second pitch size of the second bump via the first bump.

Example Embodiment 12. The integrated circuit system of example embodiment 11, wherein the bridge couples the first integrated circuit device to a package substrate via the second bump, where the second pitch size is greater than the first pitch size.

Example Embodiment 13. The integrated circuit system of example embodiment 12, including a copper pillar configurable to communicatively couple the second bump to the package substrate.

Example Embodiment 14. The integrated circuit system of example embodiment 11, wherein the second integrated circuit device is communicatively coupled to a second plurality of bumps having a uniform pitch size.

Example Embodiment 15. The integrated circuit system of example embodiment 14, including an interposer communicatively coupled to the second integrated circuit device via the second plurality of bumps and including a third plurality of bumps having different pitch sizes, where the interposer is configurable to couple the second integrated circuit device to the bridge.

Example Embodiment 16. An integrated circuit system including an integrated circuit device communicatively coupled to a plurality of bumps, where a first bump of the plurality of bumps includes a first pitch size and a second bump of the plurality of bumps includes a second pitch size, and where the first pitch size is different from the second pitch size and a bridge to couple the integrated circuit device to an additional integrated circuit device via the first bump and a package substrate via the second bump. The integrated circuit device may also include a bridge to couple the integrated circuit device to an additional integrated circuit device via the first bump and a package substrate via the second bump and the additional integrated circuit device communicatively coupled to an interconnect comprising a second plurality of bumps, wherein a pitch size of each bump of the second plurality of bumps is the same. The integrated circuit may also include an interposer with a third plurality of bumps and communicatively coupling the additional integrated circuit device and the bridge, where a third bump of the third plurality of bumps comprises a third pitch size and a fourth bump of the plurality of bumps comprises a fourth pitch size, and where the third pitch size is different from the fourth pitch size.

Example Embodiment 17. The integrated circuit system of example embodiment 16, where the integrated circuit device and the additional integrated circuit device are in a stacked configuration.

Example Embodiment 18. The integrated circuit system of example embodiment 16, where the interposer receives a signal from the additional integrated circuit device via the second plurality of bumps and passes the signal to the bridge.

Example Embodiment 19. The integrated circuit system of example embodiment 16, where the bridge is less than one reticle size.

Example Embodiment 20. The integrated circuit system of example embodiment 16, where the bridge is two reticle size and couples the integrated circuit device and the additional integrated circuit device to two additional integrated circuit devices.

What is claimed is:

1. An integrated circuit system, comprising:
a first integrated circuit device communicatively coupled to a plurality of bumps, wherein the plurality of bumps comprises a first bump of the plurality of bumps having a first pitch size and a second bump of the plurality of bumps having a second pitch size, wherein the first pitch size is different from the second pitch size; and
a bridge configurable to communicatively couple the first integrated circuit device to a second integrated circuit device via the first bump and a package substrate via the second bump.

2. The integrated circuit system of claim 1, wherein the first integrated circuit device and the second integrated circuit device are coupled in a stacked configuration.

3. The integrated circuit system of claim 1, wherein the second integrated circuit device is configurable to be embedded with a voltage regulator.

4. The integrated circuit system of claim 2, comprising a third integrated circuit device positioned laterally with respect to the second integrated circuit device and configurable as the bridge die between the first integrated circuit device and the second integrated circuit device.

5. The integrated circuit system of claim 1, comprising a copper pillar configurable to communicatively couple to the second bump via the bridge and couple the bridge to the package substrate.

6. The integrated circuit system of claim 1, wherein the second pitch size is greater than the first pitch size.

7. The integrated circuit system of claim 1, comprising:
an interconnect communicatively coupled to a second integrated circuit device and comprising a second plurality of bumps having a uniform pitch size; and
an interposer comprising a third plurality of bumps having different pitch sizes and configurable to communicatively couple to the second integrated circuit device to the bridge via the second plurality of bumps and the third plurality of bumps.

8. The integrated circuit system of claim 7, wherein the interposer is configurable to pass a signal from the second integrated circuit device to the bridge.

9. The integrated circuit system of claim 7, wherein a pitch size of the bridge is greater than the uniform pitch size of each bump of the second plurality of bumps.

10. The integrated circuit system of claim 1, wherein the first integrated circuit device and the second integrated circuit device are coupled in a front-to-back connection.

11. An integrated circuit system, comprising:
a first integrated circuit device communicatively coupled to a first plurality of bumps, wherein the first plurality of bumps comprises a first bump of the first plurality of bumps having a first pitch size and a second bump of the first plurality of bumps having a second pitch size, and wherein the first pitch size is different from the second pitch size;
a second integrated circuit device configurable to be embedded with voltage regulation circuitry, wherein the first integrated circuit device and the second integrated circuit device are in a stacked configuration; and
a bridge configurable to couple to the first integrated circuit device and the second integrated circuit device and facilitate signal transfer between the first integrated circuit device and the second integrated circuit device.

12. The integrated circuit system of claim 11, wherein the bridge is configurable to couple the first integrated circuit device to the second integrated circuit device via the first bump and couple the first integrated circuit device to a package substrate via the second bump, wherein the second pitch size is greater than the first pitch size.

13. The integrated circuit system of claim 12, comprising a copper pillar configurable to communicatively couple the second bump to the package substrate.

14. The integrated circuit system of claim 11, wherein the second integrated circuit device is communicatively coupled to a second plurality of bumps having a uniform pitch size.

15. The integrated circuit system of claim 14, comprising an interposer communicatively coupled to the second integrated circuit device via the second plurality of bumps and comprising a third plurality of bumps having different pitch sizes, wherein the interposer is configurable to couple the second integrated circuit device to the bridge.

16. An integrated circuit system, comprising:
an integrated circuit device communicatively coupled to a plurality of bumps, wherein a first bump of the plurality of bumps comprises a first pitch size and a second bump of the plurality of bumps comprises a second pitch size, and wherein the first pitch size is different from the second pitch size;
a bridge configurable to couple the integrated circuit device to an additional integrated circuit device via the first bump and a package substrate via the second bump;
the additional integrated circuit device communicatively coupled to an interconnect comprising a second plurality of bumps, wherein a pitch size of each bump of the second plurality of bumps is the same; and
an interposer comprising a third plurality of bumps and configurable communicatively couple the additional integrated circuit device and the bridge, wherein a third bump of the third plurality of bumps comprises a third pitch size and a fourth bump of the plurality of bumps comprises a fourth pitch size, and wherein the third pitch size is different from the fourth pitch size.

17. The integrated circuit system of claim 16, wherein the integrated circuit device and the additional integrated circuit device are in a stacked configuration.

18. The integrated circuit system of claim 16, wherein the interposer is configurable to receive a signal from the additional integrated circuit device via the second plurality of bumps and pass the signal to the bridge.

19. The integrated circuit system of claim 16, wherein the bridge is less than one reticle size.

20. The integrated circuit system of claim 16, wherein the bridge is two reticle size and configurable to couple the integrated circuit device and the additional integrated circuit device to two additional integrated circuit devices.
